(19) United States
(12) Patent Application Publication
(10) Pub. No.: US 2009/0188112 A1
(43) Pub. Date: Jul. 30, 2009

(54) SHAVING RAZOR WITH MODULAR BLADE PAIRS

(75) Inventors: Frank PROCHASKA, Waynesboro, VA (US); Jeffrey W. Wonderley, Fort Defiance, VA (US)

Correspondence Address: MCDERMOTT WILL & EMERY LLP, 600 13TH STREET, N.W., WASHINGTON, DC, 20005-3096, US

(73) Assignee: American Safety Razor

(21) Appl. No.: 12/249,700

(22) Filed: Oct. 10, 2008

Related U.S. Application Data
(60) Provisional application No. 60/960,758, filed on Oct. 12, 2007.

(51) Int. Cl. B26B 21/00; B26B 21/14; B26B 21/40

(52) U.S. Cl. 30/34.05; 30/50; 30/77; 30/538

(57) ABSTRACT

A shaving razor cartridge having a platform with a front edge and a back edge and a pair of opposing side edges; and a plurality of main blades, each having a shaving edge, attached to the platform in a stacked fashion such that the shaving edge of each of the main blades faces the front edge of the platform. The main blades are arranged in a plurality of modular pairs, each modular pair having a rigid spacer separating the blades, and each modular pair of blades is separately attached to the platform.

### CROSS REFERENCE TO PROVISIONAL APPLICATION

This application is based upon and claims the benefit of priority from Provisional U.S. Patent Application 60/960,758 (Attorney docket No. 044210-0421) filed on Oct. 12, 2007, the entire contents of which are incorporated by reference herein.

### TECHNICAL FIELD

The present disclosure relates to a shaving razor. The present disclosure has particular applicability to multi-blade shaving razors.

### BACKGROUND

In the manufacture of shaving razor cartridges, having multiple blades can increase the smoothness and closeness of the shaving experience. However, this increase may also result in an increase of parts required for the manufacture of such blades. In blades having multiple blades that are attached to the cartridge platform at one anchor point, the number of different blade sizes will be equal to the number of blades in the cartridge, due to the blade exposure and shaving angle of the various blades.

Oldroyd et al., U.S. Pat. No. 4,063,354, discloses a shaving unit wherein a blade unit comprises two blades separated by a spacer. A resiliently flexible metallic or plastic guard is secured to the blade unit by spot welding or other means. However, the blade unit only has two blades and thus, does not exhibit the beneficial effects of a multiple blade system of 4 or more blades.

The terms “blade exposure” and “shaving angle” represent geometrical relationships between the blade and the shaving surface (i.e., the user's skin). These terms as well as another term commonly used in the art are defined as follows. First, the term “shaving plane” means the plane tangent to skin engaging surfaces of the cartridge, sometimes referred to as a guard in front of the blades and a cap behind the blades, which respectively engage the shaving surface before and after engagement by the blade. Second, the term “blade exposure” means the distance by which the blade edge projects forwardly of the shaving plane. Third, the term “shaving angle” means the acute angle between a plane tangent to the cutting edge of the blade and the shaving plane.

Another important aspect of a shaving razor is its ability to distribute lubricant equally to each of the blades and to the face in order to facilitate the shaving experience.

Certain conventional razor cartridges (e.g. the Gillette Mach 3™) provide “wash through” areas between the blades to allow lubricant to flow from the front to the rear of the blades. However, this arrangement results in an uneven flow of lubricant to the blades. In particular, the blades closest to the ground get adequate lubrication, while the blades farthest from the guard do not.

Thus, further improvements in shaving technology are required to ensure an even distribution of shaving aids to all of the blades and to the skin.

Another approach disclosed in prior art patents illustrates a blade cartridge comprising two blades separated by a spacer with the blades and the spacer attached to a cap to form a unitary assembly.

### SUMMARY OF THE DISCLOSURE

The present disclosure provides a novel blade cartridge designed to satisfy the aforementioned needs. A novel feature of the present disclosure is the reduction in the number of blade sizes required for the cartridge. In one embodiment of the present disclosure, a shaving razor cartridge comprises a platform having a front edge and a back edge and a pair of opposing side edges; and a plurality of main blades, each having a shaving edge, attached to the platform in a stacked fashion such that the shaving edge of each of the main blades faces the front edge of the platform. The main blades are arranged in a plurality of modular pairs, each modular pair having a rigid spacer separating the blades; and each modular pair of blades is separately attached to the platform.

In another embodiment of the present disclosure, each modular pair is comprised of one major blade and one minor blade, the major blade being wider than the minor blade in a direction from the front edge to the back edge of the platform, and the minor blade is disposed above the major blade in the direction from the front edge to the back edge of the platform. In certain embodiments, each modular pair of blades is cantilevered with respect to the spacer located between the pair of blades.

In another embodiment of the present disclosure, the razor cartridge further comprises a trimmer blade having a shaving edge, wherein the shaving edge is directed towards the back edge of the platform at an 180 degree angle to that of the main blades, and the trimmer blade is located closest to the back edge of the platform with respect to the other blades. Optionally, the trimmer blade and the uppermost main blade comprise a modular pair without a separator in between.

In another embodiment of the present disclosure, each of the main blades and each spacer has a through hole, and the platform has a pin for engaging the corresponding through hole of the blades and spacer of one of the modular pairs for attaching the blades to the platform. The pin optionally has an oval or rectangular shape corresponding to the shape of the through hole of the blades and spacer in each modular pair.

In another embodiment of the present disclosure, the razor cartridge further comprises a pair of opposing end caps at the side edges of the platform, extending from the front edge to the back edge of the platform and enclosing the ends of the blades. The end caps optionally contain a reservoir for retaining a liquid, such as a fragrance, a lubricant, a botanical preparation, an herbal preparation, a medicinal preparation or another preparation. The end caps also optionally contain a lubricating element.

In another embodiment of the present disclosure, the platform has a comb-like segmented blade guard structure disposed above and below the shaving edge the trimmer blade.

The platform optionally comprises a guard in front of the shaving edges of the main blades, wherein the guard further comprises a primary guard rib arranged adjacent to and in front of the shaving edge of the main blades; a guard member with a skin engaging surface thereon arranged adjacent to and in front of the primary guard rib; and a soap bar element arranged in front of the guard member, wherein said soap bar element contains a skin engaging surface for retaining shaving aids.

In another embodiment of the present disclosure, the main blades optionally have one through hole capable of allowing a lubricant to pass through the one through hole. The through hole is optionally capable of directing the lubricant back toward a blade disposed rearward of the blade in which the through hole is located.

In another embodiment of the present disclosure, the distance between the shaving edge of any of the main blades from the shaving edge of an adjacent main blade is from 0.047 to 0.048 inches. Optionally, an angle formed by the plane of any of the main blades and the plane formed by the shaving edges of the main blades is from 22 to 25 degrees.

The razor cartridge also optionally has a pivot point located between the shaving edges of the two main blades located closest to the front edge of the platform. In addition, the razor cartridge optionally comprises a lube strip behind the shaving edges of the main blades, wherein the lube strip contains grooved portions for directing fluid towards the skin.

In another embodiment of the present disclosure, the razor cartridge further comprises a cap member connected to the platform, the cap member having a skin-engaging surface located rearwardly of the cutting edge of the uppermost main blade. The cap member optionally comprises a press fit pin, having a grooved portion, for engaging with a hole in the platform. The hole in the platform contains a ribbed portion for engaging the grooved portion of the press fit pin, and the press fit pin and hole in the platform are capable of being friction welded. In addition, the cap member optionally has a cut out portion aligned with the through hole in the main blades.

### BRIEF DESCRIPTION OF THE DRAWINGS

Reference is made to the attached drawings, wherein elements having the same reference numeral designations represent like elements throughout, and wherein:

FIG. 1 is a front perspective view of a cartridge according to an embodiment of the present disclosure.

FIG. 2 is a rear perspective view of the cartridge of FIG. 1.

FIG. 3 is a bottom perspective view of the cartridge of FIG. 1.

FIG. 4A contains views of a major blade of the cartridge of FIG. 1.

FIG. 4B contains views of a minor blade of the cartridge of FIG. 1.

FIG. 5A contains views of a platform of the cartridge of FIG. 1.

FIG. 5B is a close-up view of part of the platform shown in FIG. 5B.

FIGS. 6A-J shows an assembly sequence of the cartridge of FIG. 1.

FIGS. 7A-7C are detail and cross-sectional views of portions of the platform of FIG. 5A.

FIG. 8 shows components of the cartridge of FIG. 1.

FIGS. 9A-D contains a view of the trimmer guard ribs of another embodiment of the present disclosure.

FIG. 10 shows a schematic of flow paths of lubricant and liquid during operation of the razor.

FIG. 11A contains a view of the cap member and press fit pin

FIG. 11B is a close up view of the press fit pin

FIG. 12A is a representation of the platform detailing the holes for a press fit pin.

FIG. 12B is a close up view of a hole for a press fit pin.

### DETAILED DESCRIPTION OF THE DISCLOSURE

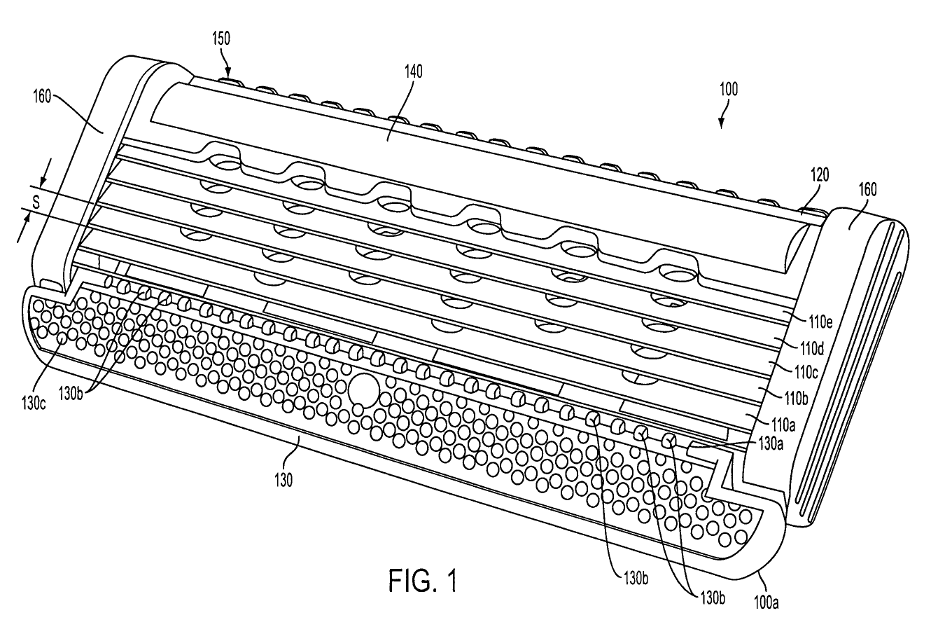

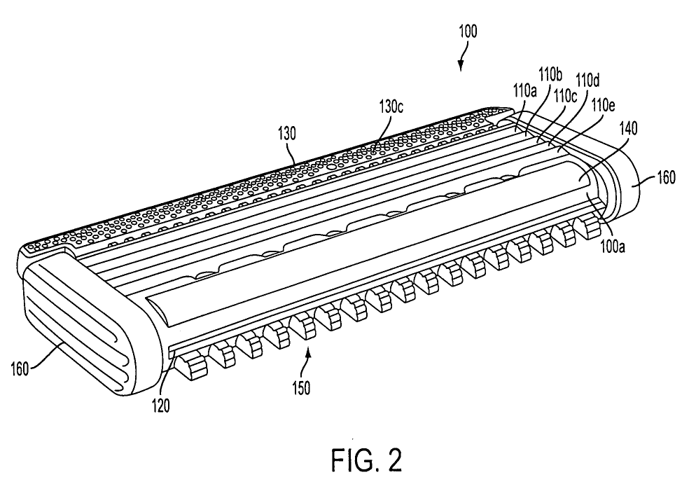

According to the present disclosure, as shown in FIGS. 1-3, 5A, and 5B, a shaving cartridge 100 is built on a platform 100a. In FIG. 1, the platform has a front edge where a guard structure 130 is located, and a back edge where a lube strip 140 is located. In one embodiment, the cartridge has main shaving blades 110a-e and a trimmer blade 120. The shaving edge of the blades 110a-e are facing the front edge of the platform.

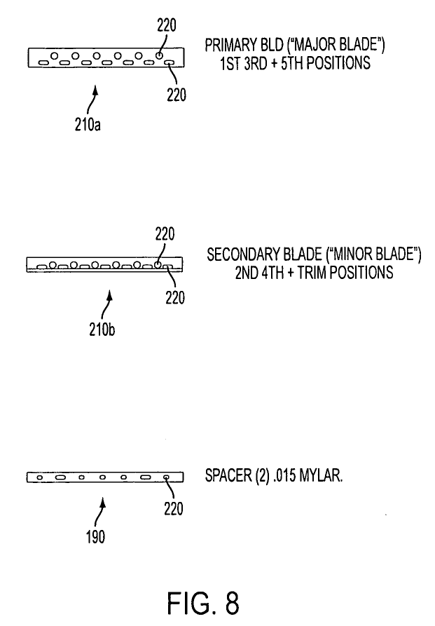

The main blades are arranged in modular pairs, such that each modular pair assembly consists of two blades 110 separated by a spacer 190, as shown in FIG. 8. The blades of the modular pair 210 consist of a major blade 210a and a minor blade 210b disposed above the major blade 210a in a direction from the front edge to the back edge of the platform 100a.

The spacer is comprised of a rigid material, such as a hardened plastic. The blades are cantilevered with respect to the spacer 190 located between the blades 210. The rigidity of the spacer allows the spacer to restrain the downward motion of the blades, and provides a straightening method longitudinally. Teeth optionally located on the spacer provide for further control of the downward motion of the blades.

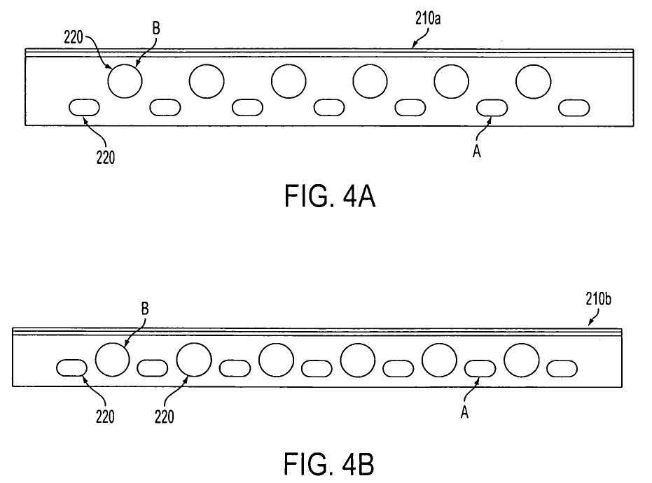

The modular blade pair and spacer have through holes by which the modular pair assembly is attached to the platform. For example, as is seen in FIG. 8, the major blade 210a, minor blade 210b and spacer 190 each have 7 oval through holes 220. Optionally, the through holes have a rectangular shape. These through holes 220, also shown in FIG. 4A, are designed to improve the fit of the blades to the platform with greater accuracy. The through holes 220 have two types. One type labeled “A” is for fitting the blade over the staking pins 180. The through hole labeled “B” is for flow of the lubricant and other liquids, discussed below.

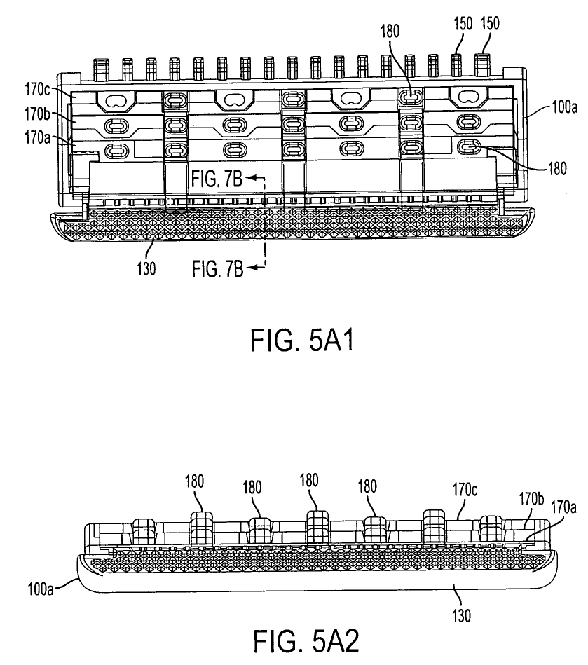

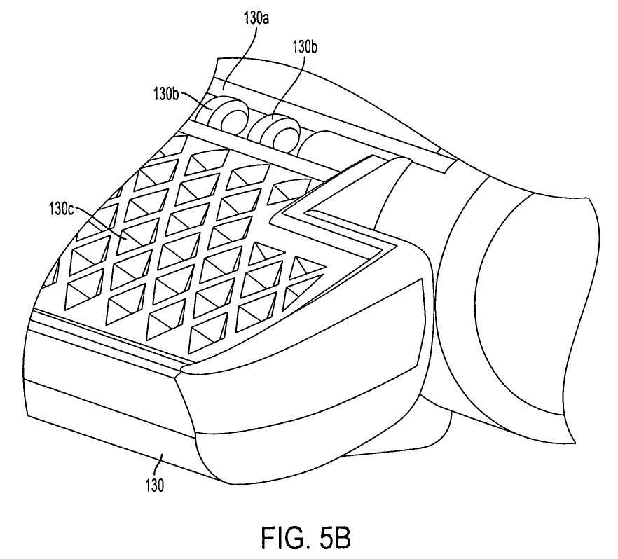

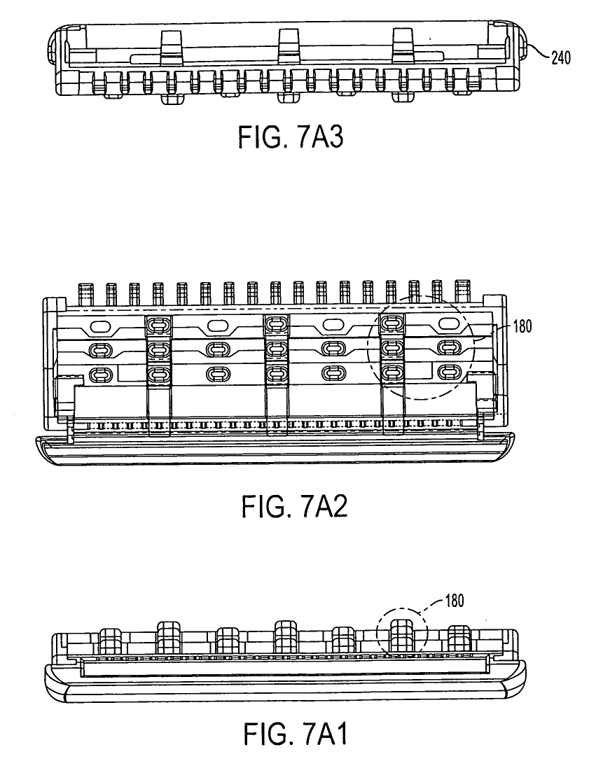

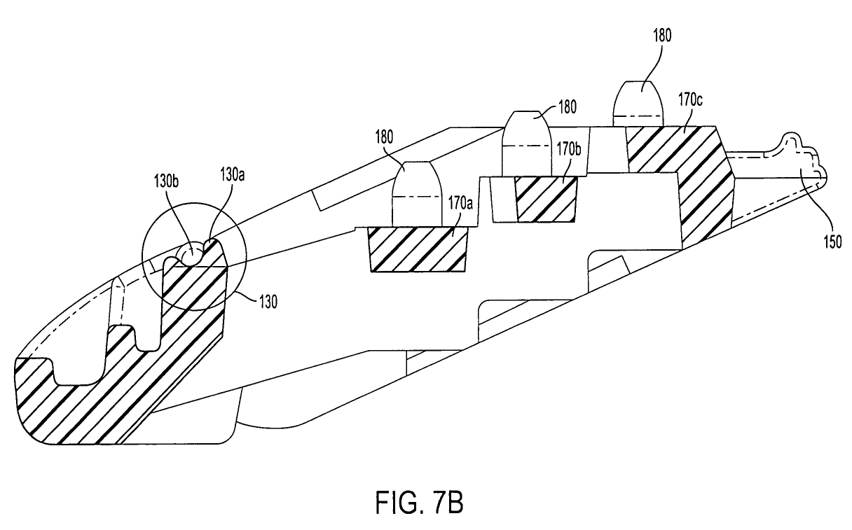

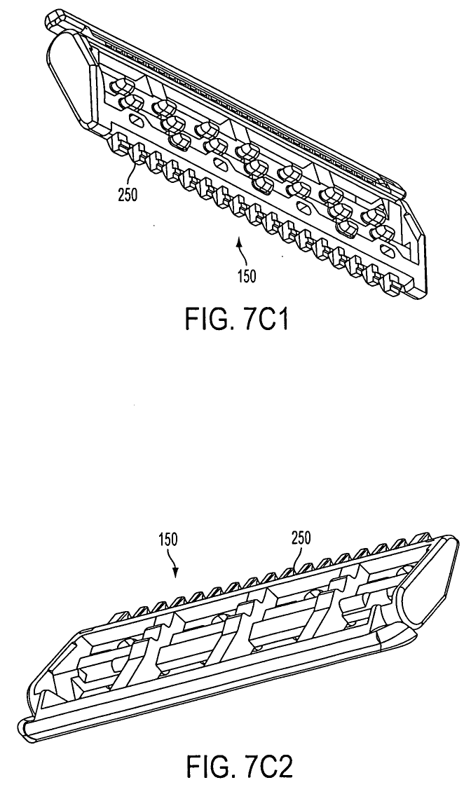

As shown in FIGS. 5A and 7B, the platform 100a has three distinct blade seats 170a-c, each with a row of staking pins 180. Staking pins 180 are tapered in a direction from the base of the pin closest to the surface of the platform 100a to the tip of the staking pin 180. The through holes 220 in the spacer 190 and blades 110 fit over the staking pins 180, which are then heat welded in place to form a bulbous cap to hold the modular pair assembly in place.

The razor cartridge is optionally equipped with a trimmer blade. In FIG. 1, the trimmer blade 120 and the uppermost shaving blade 110e are in the same plane; that is, their shaving edges form an included angle of 180 degrees. The shaving edge of the trimmer blade 120 is therefore directed toward the back edge of the platform 100a so that when shaving, the user can rotate the razor 180 degrees to utilize the trimming feature of the razor.

The trimmer blade 120 can also be a part of the topmost modular pairs of blades. However, the trimmer blade 120 is inserted over the staking pins in an opposite manner as that of the main blades such that the shaving edge of the trimmer blade 120 faces the back edge of the platform. In addition, the modular pair comprising the trimmer blade optionally does not include a spacer 190 in the assembly.

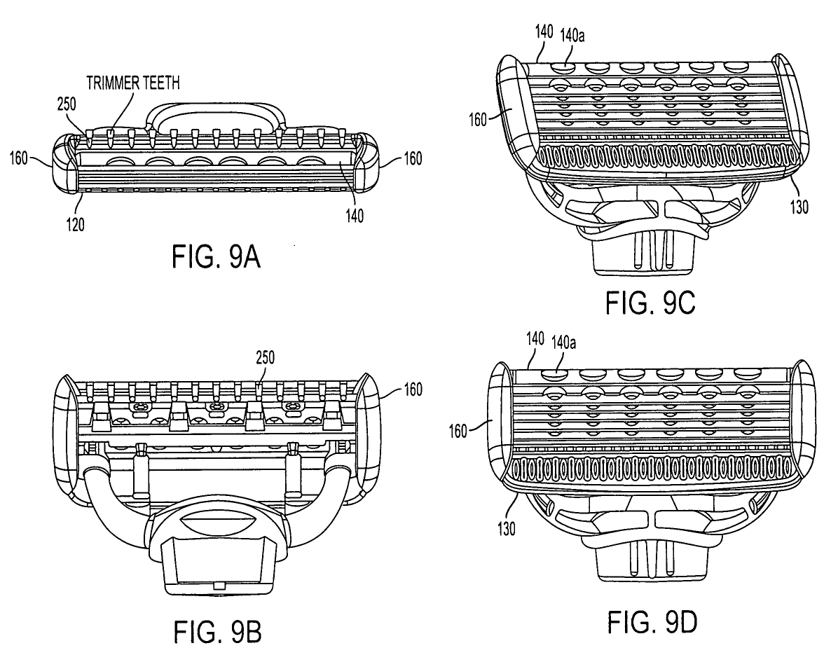

The cartridge optionally has a comb-like segmented blade guard 150 structure disposed above and below the shaving edge of the trimmer blade 120. As is shown in FIG. 9A, the blade guard 150 has a series of ridged protrusions 250 above and below the plane of the trimmer blade 150 for the prevention of cuts and abrasions on the skin during trimming. The comb-like segmented blade guard structure 150 permits effective trimming of both short and long hair.

The cartridge also has a guard 130 ahead of the main shaving blades 110. The guard structure 130. As shown in FIGS. 1 and 5B, a continuous control surface 130a is provided adjacent to and ahead of the shaving edge of first blade 110a, and is called the primary guard rib. The exposure of the first blade 110a of the group of five main shaving blades is positive relative to the primary guard rib 130a. The next structure ahead of rib 130a in the direction away from the first shaving edge is a transverse row of virtual guard elements 130b, which do not interrupt the continuous nature of the primary guard rib 130a. The virtual guard elements 130b assist the flow of the skin over the primary guard rib 130a, thereby allowing more lubricants to reach the first shaving edge (the edge of blade 110a) and reducing the pressure of the user's skin against this edge. The guard 130 also has a patterned elastomeric soap bar element 130c. The guard 130 provides an effective means for preventing cuts and abrasions caused by a razor blade being repeatedly passed over the skin of a shaver. The guard provides the portions of the skin engaging edges with a blade exposure that prevents overexposure of the blades to the skin, while allowing the remainder of the skin engaging edges of the blade to provide a close shave.

The cartridge also has a rigid lube strip 140 behind the main shaving blades. The lube strip 140 for the main shaving blades 110a-e also functions as the lube strip for the trimmer blade 120. In other words, lube strip 140 contacts the shaving surface both during shaving and during trimming. The shave angle of the trimmer is about 26 to about 32 degrees; for example, about 30 degrees.

As shown in FIG. 9D, the lube strip 140 can optionally contain grooved portions 140A for directing fluid towards the skin. These grooved portions 140A enhance flowthrough of lubricant and moisture for subsequent shaving strokes, continuously reapplying moisture to the lube strip 140 to reactivate it. The grooved portions 140A are optionally aligned with the through holes 220 for greater circulation of the lubricant towards the blades and skin surface.

As shown in FIGS. 4A and 4B, the blades also have a second series of through holes B which have multiple flow paths for lubricant removed by each successive blade edge. These through holes are configured to return a portion of the lubricant to the skin surface ahead of the next blade edge. Thus, the blades towards the rear of the cartridge receive lubricant as well as the front blades. The through holes are aligned in a direction from the front edge to the back edge of the platform in order to allow for lubricant to more easily flow through and preventing starvation of lubricant to the upper blades. This results in more equal distribution of lubricant to all the blades as well as the skin.

The disclosed cartridge construction incorporates opposing end caps 160 that envelop the cartridge ends to shield the blade corners, retain the cap ends, and provide changeable styling or identification means. The end caps 160 optionally snap on to protect blade ends. In addition, the end caps 160 optionally utilize a low friction material or coating to reduce abrasion in the repeated passing of the razor over the skin surface. Optionally, the end caps 160 contain a reservoir for retaining a liquid, such as a fragrance, a lubricant, a botanical preparation, an herbal preparation, a medicinal preparation or another preparation.

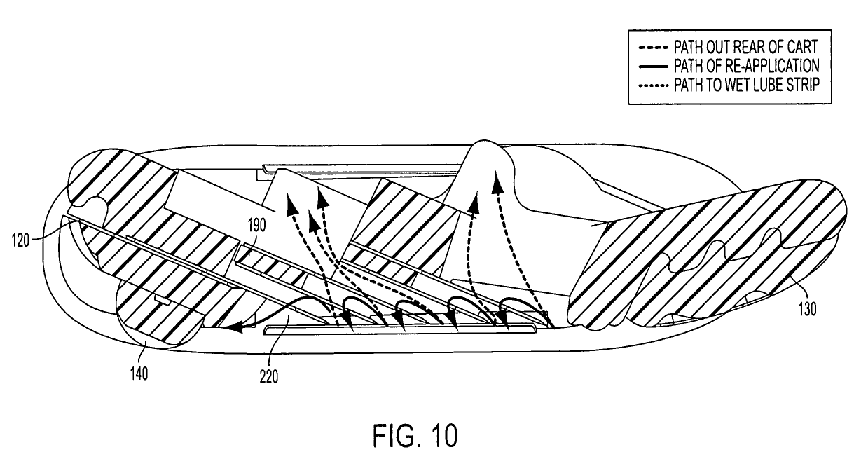

The blades are shown being assembled to the platform with a spacer 190, best seen in FIG. 8, between the first and second blades and a spacer between the third and fourth blades. The flow through holes B in the blades permit lubricants to flow back to the skin after each blade passes. The rear portion of the cartridge will therefore not be “starved” of lubricant during the shaving process. This flow pattern of lubricant to the blades and skin is also shown in more detain in FIG. 10. As can be seen, the design of the through holes allows for lubricant and other liquids to flow by three distinct pathways—a path out of the rear of the cartridge 100 as shown by the dotted line, a path directing the liquid back to the skin surface and in front of the blade immediately to the rear of the through hole, and a path to the rear of the cartridge to wet the lube strip.

In one embodiment, the blade span, shown as reference character “S” in FIG. 1, is 0.047/0.048 inches. The shave angle of the cartridge is from about 22 to about 25 degrees; for example, 23.5 degrees. The exposure of the first blade 110a to the adjacent continuous control surface 130a is positive, while exposure to the virtual guard elements 130b is negative.

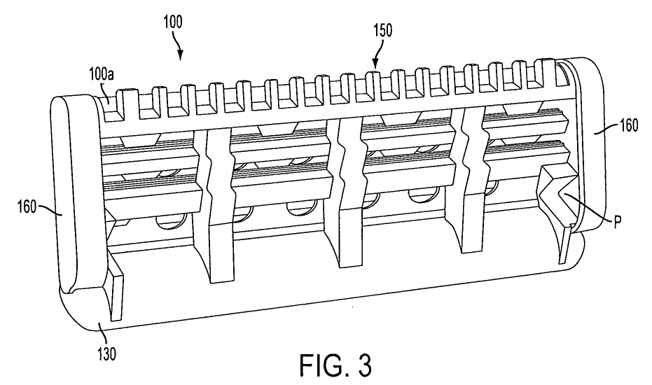

The cartridge pivot point P, as shown in FIG. 3, is between the first and second shaving edges (i.e., between the edges of blades 110a and 110b). Thus, not all the shaving edges are on the same side of the pivot point P. In one embodiment, the cartridge pivot range is 40 degrees.

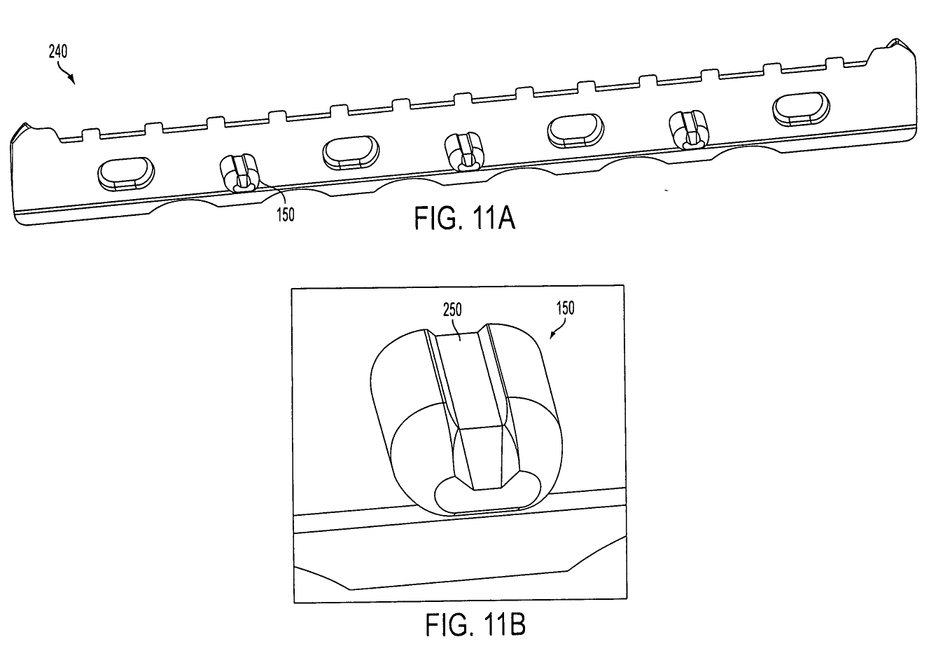

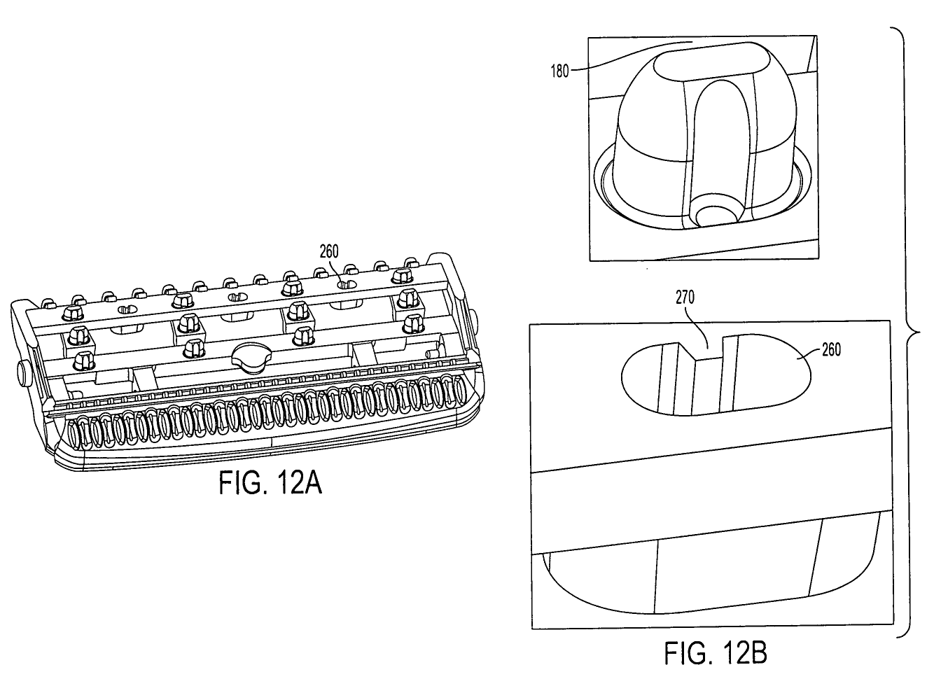

The razor cartridge optionally further comprises a cap member 240 connected to the platform 100a. The cap member stabilizes the blades of the cartridge on the platform. As shown in FIG. 11A, the cap member comprises a series of press fit pins 150, which engage with openings in the back edge of the platform. The press fit pins optionally contain a groove 240a (see, FIG. 11B) which engages with a rib 270 in the opening 260 (see, FIGS. 12A and 12B) in the back edge of the platform 100a for further stability when attaching the cap 240 to the platform 100a. The cap optionally is friction welded to the platform 100a during attachment.

### EXAMPLE

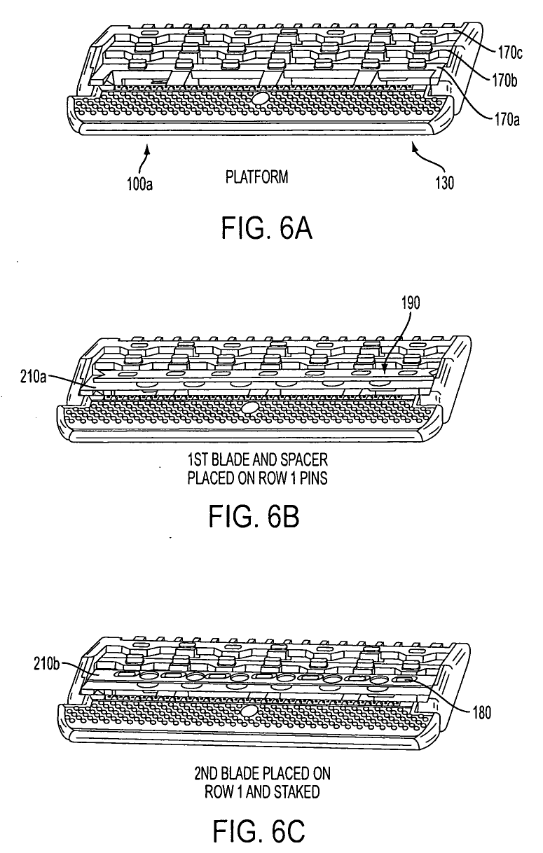

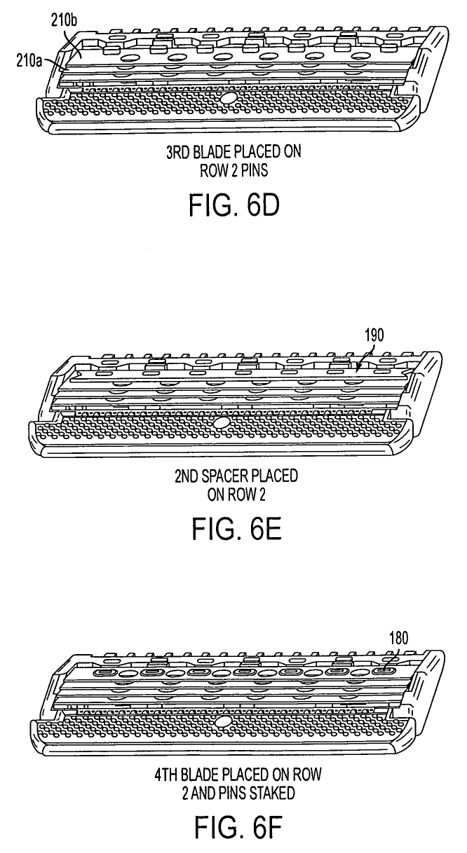

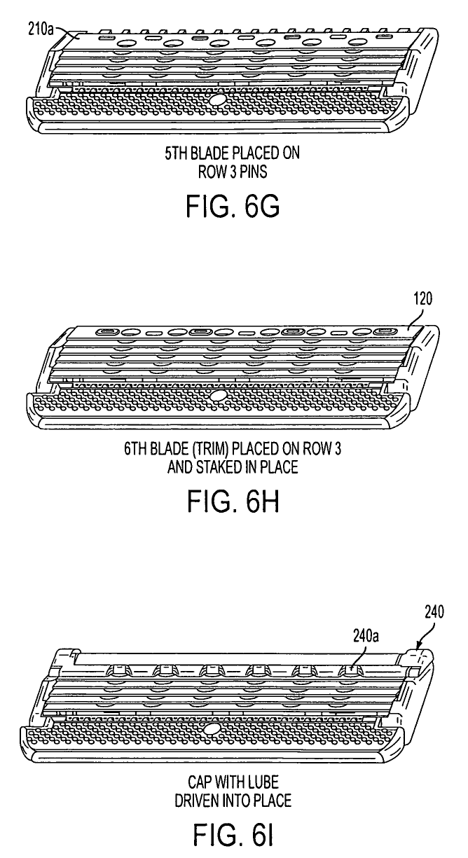

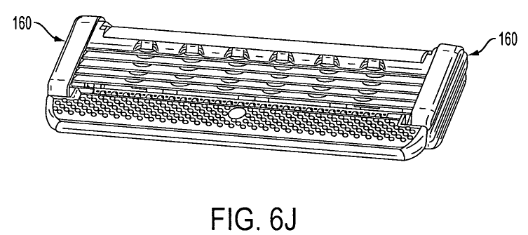

FIG. 6 shows a graphic representation of the steps-by-step process of manufacturing the cartridge of one embodiment of the present disclosure.

FIG. 6a shows the platform 100a featuring the three stepped levels 170a-c for blade attachment and the guard 130 on the front edge of the platform. In FIG. 6b, a major blade 210a and spacer 190 are placed on the platform by aligning the staking pins with the oval through holes in the blade and spacer. FIG. 6c shows the placing of a minor blade 210b on the same set of staking pins 180 to form the first modular pair assembly followed by staking the pins to firmly attach the modular pair assembly to the platform.

FIGS. 6d-f repeat the modular pair placing and pin staking to form the second modular pair assembly and attachment thereof to the platform. In FIGS. 6g-h, a third modular pair is formed, but without a spacer in between the blades. The 6th blade is placed in an opposite direction as the previous 5 blades to form the trimmer blade 120. FIG. 6i shows the placing of the cap member 240 with grooves 240a on the back edge of the platform 100a to secure the blades, followed by the placing of end caps 160 in FIG. 6j to cover the side edges of the blades to prevent injury during shaving and further securing of the blades.

Only an exemplary embodiment of the disclosed cartridge and but a few examples of its versatility are shown and described in the present disclosure. It is to be understood that the present disclosure is capable of use in various other combinations and environments and is capable of changes or modifications within the scope of the inventive concept as expressed herein.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present disclosure. However, it should be recognized that the present disclosure can be practiced without resorting to the details specifically set forth. In other instances, well known processing structures have not been described in detail, in order not to unnecessarily obscure the present disclosure.

What is claimed is:

1. A shaving razor cartridge comprising:
a platform having a front edge and a back edge and a pair of opposing side edges;
a plurality of main blades, each having a shaving edge, attached to the platform in a stacked fashion such that the shaving edge of each of the main blades faces the front edge of the platform;
wherein the main blades are arranged in a plurality of modular pairs, each modular pair having a rigid spacer separating the blades; and
wherein each modular pair of blades is separately attached to the platform.

2. The razor cartridge of claim 1, wherein each modular pair is comprised of one major blade and one minor blade, the major blade being wider than the minor blade in a direction from the front edge to the back edge of the platform, and the minor blade is disposed above the major blade in the direction from the front edge to the back edge of the platform.

3. The razor cartridge of claim 1, wherein each modular pair of blades is cantilevered with respect to the spacer located between the pair of blades.

4. The razor cartridge of claim 1, further comprising a trimmer blade having a shaving edge, wherein the shaving edge is directed towards the back edge of the platform at an 180 degree angle to that of the main blades, and the trimmer blade is located closest to the back edge of the platform with respect to the other blades.

5. The razor cartridge of claim 4, wherein the trimmer blade and the uppermost main blade comprise a modular pair.

6. The razor cartridge of claim 1, wherein each of the main blades and each spacer has a through hole, and the platform has a pin for engaging corresponding through hole of the blades and spacer of one of the modular pairs for attaching the blades to the platform.

7. The razor cartridge of claim 6, wherein the pin has an oval or rectangular shape corresponding to the shape of the through hole of the blades and spacer in each modular pair.

8. The razor cartridge of claim 1, further comprising:
a pair of opposing end caps at the side edges of the platform, extending from the front edge to the back edge of the platform and enclosing the ends of the blades.

9. The razor cartridge of claim 8, wherein said end caps contain a reservoir for retaining a liquid.

10. The razor cartridge of claim 9, wherein said liquid is a fragrance, a lubricant, a botanical preparation, an herbal preparation, a medicinal preparation or another preparation.

11. The razor cartridge of claim 8 wherein said end caps further contain a lubricating element.

12. The razor cartridge of claim 4, wherein the platform has a comb-like segmented blade guard structure disposed above and below the shaving edge the trimmer blade.

13. The razor cartridge of claim 1, wherein the platform comprises a guard in front of the shaving edges of the main blades, wherein the guard further comprises:
a primary guard rib arranged adjacent to and in front of the shaving edge of the main blades;
a guard member with a skin engaging surface thereon arranged adjacent to and in front of the primary guard rib; and
a soap bar element arranged in front of the guard member,
wherein said soap bar element contains a skin engaging surface for retaining shaving aids.

14. The razor cartridge of claim 1, wherein said main blades further have one through hole capable of allowing a lubricant to pass through the one through hole.

15. The razor cartridge of claim 14, wherein said through hole is capable of directing the lubricant back toward a blade disposed rearward of the blade in which the through hole is located.

16. The razor cartridge of claim 1, wherein the distance between the shaving edge of any of the main blades from the shaving edge of an adjacent main blade is from 0.047 to 0.048 inches.

17. The razor cartridge of claim 1, wherein an angle formed by the plane of any of the main blades and the plane formed by the shaving edges of the main blades is from 22 to 25 degrees.

18. The razor cartridge of claim 1, wherein the cartridge has a pivot point located between the shaving edges of the two main blades located closest to the front edge of the platform.

19. The razor cartridge of claim 1, further comprising a lube strip behind the shaving edges of the main blades, wherein the lube strip contains grooved portions for directing fluid towards the skin.

20. The razor cartridge of claim 14, further comprising a cap member connected to said platform, said cap member having a skin-engaging surface located rearwardly of said cutting edge of the uppermost main blade.

21. The razor cartridge of claim 20, wherein said cap member contains a press fit pin, having a grooved portion, for engaging with a hole in the platform, the hole in the platform contains a ribbed portion for engaging with the grooved portion of the press fit pin, and
wherein the press fit pin and hole in the platform are capable of being friction welded.

22. The razor cartridge of claim 20, wherein said cap member has a cut out portion aligned with the through hole in the main blades.
